(19) United States
(12) Patent Application Publication
(10) Pub. No.: US 2003/0046428 A1
(43) Pub. Date: Mar. 6, 2003

(54) Method for generating domain name for device intermittently connected to fixed network

(76) Inventors: Johannes Elg, Malmo (SE); Johan Sorensen, Eslov (SE)

Correspondence Address: James O. Skarsten, Jenkens & Gilchrist, P.C., Suite 3200, 1445 Ross Avenue, Dallas, TX, 75202-2799, US

(21) Appl. No.: 09/948,470

(22) Filed: Sep. 6, 2001

(51) Int. Cl. G06F 15/16; G06F 9/00

(52) U.S. Cl. 709/245; 713/1

(57) ABSTRACT

A method is provided for generating a domain name to uniquely identify a selected device in a class of devices when the selected device is connected to a fixed network such as the Internet, the selected device being disposed for intermittent connection to and disconnection from the fixed network. The method includes the step of embedding a permanent address into the selected device which uniquely distinguishes it from all other devices in the class. A domain name is generated from the permanent address, in textual form such as hexadecimal, which is adapted for use with a specified communication protocol such as HTTP. The domain name also includes a component identifying a second independent network to which the selected device and other devices in the class are configured.

### BACKGROUND OF THE INVENTION

1. Technical Field of the Invention

The invention disclosed and claimed herein generally pertains to a method for generating a host/domain name to identify a device which is connected to a network on an intermittent or part-time basis. More particularly, the invention pertains to a method of the above type wherein the network is a fixed local network, and the device is a mobile device such as a mobile phone or the like which for some reason has use for a host/domain name. Even more particularly, the invention pertains to a method of the above type wherein the device can be selectively connected to and disconnected from the fixed network, and can alternatively be connected to an independent or stand alone network.

2. Description of Related Art

Nodes or hosts in a network using the Transmission Control Protocol/Internet Protocol (TCP/IP) are addressed using an Internet Protocol (IP) address. This is a 32-bit or 128-bit number. Since this type of address is cumbersome to manage and remember for a user, hosts on networks such as the Internet which use the above protocol are usually also given textual names, or “host names”, which when combined with “domain names” form unique identifiers of the hosts on the network. These names can be translated or converted into IP-addresses by various means, such as by means of Domain Name Service (DNS), if and when required. Some upper layer communication protocols, such as Hypertext Transmission Protocol (HTTP), make extensive use of the host/domain name rather than the IP-address.

A fixed network is a network wherein respective hosts or users typically remain connected to the network on a permanent basis. Accordingly, host/domain names are typically assigned to respective hosts by a network server, or by an administrator in accordance with a network policy. Hereinafter, for convenience the terms “host/domain name” and “domain name” are used interchangeably. Also for convenience, a network using the TCP/IP protocol is hereinafter referred to as an IP network.

There is increasing interest in providing mobile phones and other portable electronic devices with the capability to connect and communicate wirelessly with an IP network. As an example of this interest, the assignee herein, a major supplier of mobile telecommunications equipment and systems, has initiated a program known as Bluetooth Wireless Technology to develop wireless communications having this capability. More particularly, the Bluetooth network enables wireless communication over short ranges between devices such as mobile phones, portable PCs and laptop computers. However, on occasion it will also be very beneficial to connect devices of the Bluetooth network to an IP network. For example, it could be very useful to interconnect a laptop computer and a mobile phone configured to the Bluetooth network, and then establish a connection between the mobile phone and the IP network, in order to connect the laptop thereto through the mobile phone. It could also be useful to connect the mobile phone to the IP network to make use of related features built into the phone. However, because the mobile phone is a highly portable device, its connection to the IP network would be intermittent and nonpermanent.

Since a mobile Bluetooth device of the above type is not permanently connected to an IP network, the Bluetooth device is not registered thereon. Accordingly, textual host/domain names cannot be assigned to the Bluetooth device by an IP network server or administrator, as described above. Moreover, some Bluetooth devices support TCP/IP directly and others do not. However, as indicated above, it may be desirable for a Bluetooth device to be able to randomly or intermittently connect to the IP network even if it does not support TCP/IP. Accordingly, each Bluetooth device must be provided with a unique address and domain name which can be incorporated into a Uniform Resource Locator (URL).

As is known in the art, a URL identifies a data source on an IP network, and is made up of several components including a domain name and a communication protocol. One such protocol, the HTTP, is of higher level than the TCP/IP protocol. The self-generated URL is applicable within a local Bluetooth network, which may or may not be bridged to a local area network (LAN), and which may or may not use TCP/IP on the Bluetooth part of the network.

### SUMMARY OF THE INVENTION

In accordance with the invention, it has been recognized that every device pertaining to a network such as the Bluetooth network has a unique 48-bit address built or otherwise incorporated into it. Thus, each such address is embedded in and identifies a specific hardware device. A Bluetooth address is a kind of media access control (MAC) address. Accordingly, the invention is intended to apply to a Bluetooth address or any other MAC address. By automatically generating respective domain names from each of these addresses, a device will be uniquely distinguished from all other devices of the same class of MAC addresses. Usefully, the domain name also includes a component which identifies the Bluetooth or other network to which the hardware device is configured, and to which it belongs.

In one embodiment, the invention is directed to a method for generating a domain name to uniquely identify a selected device when the selected device is connected to a specified fixed network, the selected device being disposed for intermittent connection to and disconnection from the specified network. As stated above, a permanent MAC address is embedded into the device which uniquely distinguishes it from all other devices of the same class. Accordingly, a domain name is generated from the permanent address, the domain name being adapted for use with a specified communication protocol associated with the specified network. In accordance with the scope of the invention, a network on which this invention is applicable may comprise a set of Bluetooth devices, or any set of devices connected together on a LAN, where there may or may not exist a way to connect the Bluetooth devices to the LAN.

Preferably, the domain name is generated in a textual form such as hexadecimal notation. Preferably also, the specified network comprises a fixed network such as an IP network, and the domain name is incorporated into a URL which includes a communication protocol such as HTTP. The domain name identifies the selected device and its associated node to a user of the fixed network when the device is connected thereto. Usefully, the selected device comprises a mobile phone. In another embodiment, the device comprises an ethernet card or the like.

### BRIEF DESCRIPTION OF THE DRAWINGS

FIG. 1 is a schematic diagram illustrating an independent wireless communication network such as the Bluetooth network.

FIG. 2 is a schematic diagram showing a device configured for the network of FIG. 1 connected to an IP network on a nonpermanent basis.

FIG. 3 is a block diagram illustrating an embodiment of the invention.

### DETAILED DESCRIPTION OF THE PREFERRED EMBODIMENT

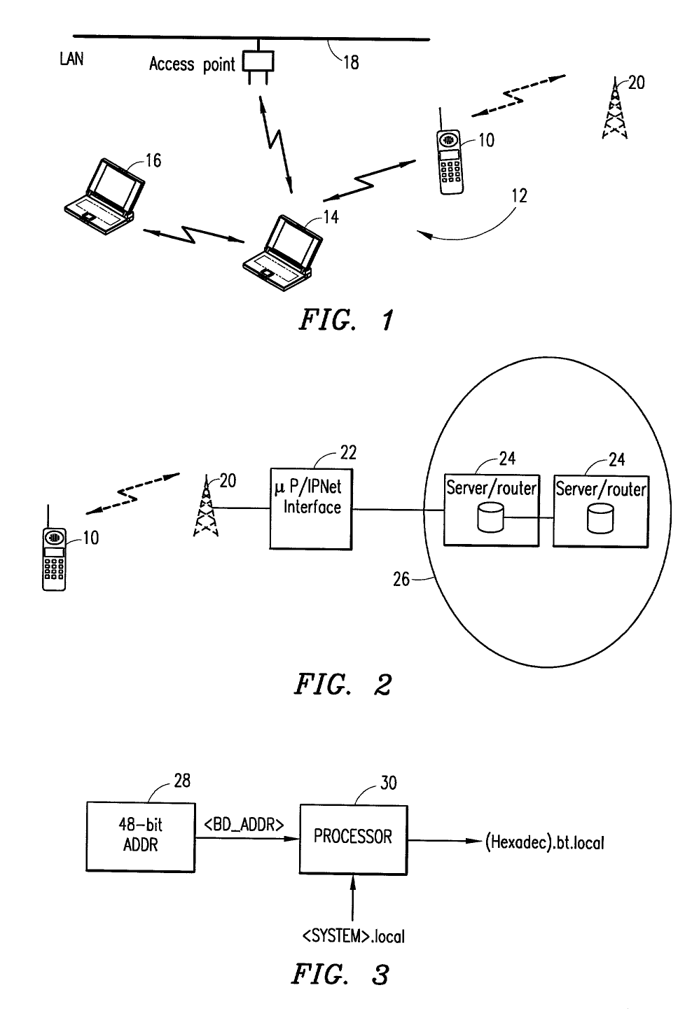

Referring to FIG. 1, there is shown a mobile phone or like device 10 which is configured or constructed to be part of an independent or stand alone network 12. That is, network 12 is not part of a fixed IP network and may or may not use the TCP/IP communication protocol. Network 12 may comprise, for example, the Bluetooth network referred to above although the invention is not limited thereto. By way of illustration and not limitation, network 12 further includes a laptop computer 14 which is disposed to communicate with mobile phone 10, another laptop computer 16 and the access point of a local area network (LAN) 18. FIG. 1 further shows mobile phone 10 adapted for communication with a cellular or mobile telecommunications network, represented in FIG. 1 as tower antenna 20.

Referring to FIG. 2, there is shown mobile telecommunications network 20 connected through a mobile phone network/IP network interface 22 to servers 24 of IP network 26. Thus, mobile phone 10 can be connected to servers 24 and thereby establish communication with users of IP network 26. Interface 22 comprises one of a number of currently available configurations known to those of skill in the art. As stated above, the mobile phone 10 may not implement the TCP/IP communication protocol, but does implement a higher protocol layer such as HTTP. Also, the mobile phone is only connected to IP network 26 intermittently and sometimes is disconnected from it. However, the mobile phone still requires a host/domain name for some reason, such as to communicate with IP network 26. Referring to FIG. 3, there is shown a storage device 28, such as a memory chip or the like, which is contained in mobile phone 10. An address such as a 48-bit address, referred to herein as <BD_ADDR>, is permanently embedded into or fixed upon device 28 when mobile phone 10 is constructed, and uniquely identifies mobile phone 10 from every other device of network 12. Each of such other devices is also provided with a unique 48-bit address of similar type.

Referring further to FIG. 3, there is shown the 48-bit address <BD_ADDR> coupled to a processor 30. Processor 30 also receives or contains a local network address, or network specific tag <SYSTEM>.local, which particularly identifies network 12. If network 12 is the Bluetooth network described above, <SYSTEM> is usefully selected to be “.bt”. Processor 30 operates to convert the 48-bit address to a textual form, preferably hexadecimal, such as “1234ABCD57”. The network specific tag or identifying component is then joined thereto, to provide the host/domain name “1234ABCD57.bt.local”. Processor 30 may be operated automatically to generate this name, which will uniquely identify mobile phone 10 as a source to any IP network user. Such name may be used to construct a URL for the IP network as follows: http://1234ABCD57.bt.local/. Thus, the generated host/domain name can be used to uniquely address a node associated with mobile phone 10, even though mobile phone 10 does not implement the Internet protocol TCP/IP, as stated above.

In a useful modification of the invention, the address component <BD_ADDR> is prefixed with “0x”. This prefix is a standard conventionally used in programming to indicate a number in hexadecimal notation. In the subject matter portion of the domain name, the hexadecimal number is positioned between the prefix and the next-following period. For the above host/domain name generated by processor 30, the next-following period would be the left-most period in “.bt.local”, the network identifying component. Thus, by using the prefix the network identifying component .bt.local can be used for both automatically generated host/domain names from <BD_ADDR>, and for manually assigned host names. Examples of automatically generated names are 0x1234ABCD57.bt.local and http://0x1234ABCD57.bt.local. An example of a manually assigned name would be .JohnsLaptop.bt.local. In addition to enabling host/domain names to be generated automatically and uniquely, a host/domain name of the invention can be used to address an IP network node associated with a mobile phone 10, even though the mobile phone node does not have the IP network Protocol implemented, as stated above. Moreover, an embodiment or implementation of the invention can determine the host/domain name of another node without use of DNS or other “address to name” translation methods, and without user intervention.

For devices that do not implement IP and HTTP, an alternative is to use the OBEX protocol. URLs, containing unique host/domain names for such devices generated in accordance with the invention, may be used to address those devices and objects therein for retrieval using OBEX.

Obviously, many modifications and variations of the present invention are possible in light of the above teachings. It is therefore to be understood that within the scope of the disclosed concept, the invention may be practiced otherwise than as has been specifically described.

What is claimed:

1. A method for generating a domain name to uniquely identify a selected device in a class of devices when said selected device is connected to a first network, wherein said selected device is disposed for intermittent connection to and disconnection from said first network, and has a permanent embedded address which is unique in said class, said method comprising:
generating a domain name from said permanent address which may be implemented for use with a communication protocol associated with said network.

2. The method of claim 1 wherein:
said domain name is generated by representing said permanent address in a specified textual form.

3. The method of claim 2 wherein:
said specified textual form comprises a hexadecimal notation.

4. The method of claim 1 wherein:
said selected device is associated with a second network which is different from said first network.

5. The method of claim 4 wherein:
said second network comprises a Bluetooth Wireless Technology network.

6. The method of claim 3 wherein:
said domain name includes a prefix indicating that an address is encoded in a portion of said domain name which is positioned between said prefix and a network identifying component which identifies said Bluetooth network.

7. The method of claim 6 wherein:
said prefix comprises the characters 0x.

8. The method of claim 5 wherein:
said permanent address of said selected device comprises a MAC address.

9. The method of claim 8 wherein:
said permanent address is uniquely associated with said Bluetooth network.

10. The method of claim 1 wherein:
said first network comprises a fixed network.

11. The method of claim 10 wherein:
said first network comprises an IP network.

12. The method of claim 1 wherein:
said domain name and said communication protocol are respectively incorporated into a uniform resource locator to identify said selected device when said selected device is connected to said fixed network.

13. The method of claim 12 wherein:
said protocol comprises the HTTP protocol.

14. The method of claim 12 wherein:
said protocol comprises the OBEX protocol.

15. The method of claim 1 wherein:
said selected device comprises a mobile telecommunication device.

16. The method of claim 1 wherein:
said device comprises an ethernet card.

17. A method for generating a domain name to uniquely identify a selected device in a class of devices when said selected device is connected to a first network, wherein said selected device is disposed for intermittent connection to and disconnection from said first network, and has a permanent embedded address which uniquely identifies said selected device with respect to a second network, said method comprising the steps of:
generating a domain name from said permanent address which may be implemented for use with a communication protocol associated with said first network; and
joining a network specific tag, which particularly identifies said second network, to said generated domain name

18. The method of claim 17 wherein:
said first network comprises an IP network, and said second network is associated with Bluetooth Network Technology.

19. The method of claim 18 wherein:
said domain name is generated by representing said permanent address in a specified textual form.

20. The method of claim 19 wherein:
said selected device comprises a mobile telecommunication device.
